(19) United States
(12) Patent Application Publication
(10) Pub. No.: US 2006/0225978 A1
(43) Pub. Date: Oct. 12, 2006

(54) Adjustable shock absorbing device for a front fork of a bicycle

(76) Inventor: Shoei-Muh Yun, Taichung (TW)

Correspondence Address: Rabin & Berdo, P.C., Suite 500, 1101 14th Street, Washington, DC, 20005, US

(21) Appl. No.: 11/092,698

(22) Filed: Mar. 30, 2005

(51) Int. Cl. F16F 9/34

(52) U.S. Cl. 188/299.1; 188/266.3

(57) ABSTRACT

A shock absorbing device has an outer tube, a sliding tube, an inner tube, a piston and a flow controlling valve. An oil passage is defined between the outer tube, the sliding tube and the inner tube and is filled with oil. The flow controlling valve is attached to the inner tube to control the oil flow in the oil passage and has a plug, a valve body, a valve rod, a valve disk and a biasing member. The valve body is attached to the plug and has a central passage and a side opening communicating with the central passage. The valve rod is rotatably mounted into the central passage, and a tiny gap is defined between the central passage and the valve rod. A flow notch is defined in the valve rod and selectively aligns with the side opening when the valve rod is rotated.

### BACKGROUND OF THE INVENTION

1. Field of the Invention

The present invention relates to a shock absorbing device, and more particularly to an adjustable shock absorbing device for a front fork of a bicycle.

2. Description of Related Art

To increase the comfort of riding a bicycle, a shock absorber is commonly mounted on the front fork of the bicycle to keep shock from being transmitted to the handlebars of the bicycle. However, the conventional shock absorber is not adjustable in the return speed of the absorber, and this means that the conventional shock absorber returns to its original condition at a same speed no matter how rough the terrain on which the bicycle runs. Therefore, the conventional shock cannot meet users' different needs and is not versatile in use.

To overcome the shortcomings, the present invention tends to provide a shock absorbing device to mitigate or obviate the aforementioned problems.

### SUMMARY OF THE INVENTION

The main objective of the invention is to provide a shock absorbing device that is adjustable in a return speed. The shock absorbing device has an outer tube, a sliding tube, an inner tube, a piston and a flow controlling valve. The outer tube has a closed top, an open bottom and an inner space. The sliding tube has an open top slidably extending into the open bottom of the outer tube, a closed bottom and an inner space. The inner tube is securely mounted inside the outer tube and has a top, a bottom and an inner space. An oil passage is defined between the inner space of the outer tube, the sliding tube and the inner tube and is filled with oil. The piston is slidably mounted inside the inner tube and is securely connected to the sliding tube with a piston rod. The flow controlling valve is attached to the top of the inner tube to control the oil flow of the oil in the oil passage and has a plug, a valve body, a valve rod, a valve disk and a biasing member. The plug is attached to the top of the inner tube and has a central hole and multiple channels defined through the plug. The channels are arranged around the central hole. The valve body is attached to the plug and has a central passage defined through the valve body and a side opening radially defined in the valve body and communicating with the central passage. The valve rod is rotatably mounted into the central passage of the valve body and has a bottom end corresponding to the side opening in the valve body. The valve disk is attached to the plug to close the channels in the plug. The biasing member is mounted around the valve body and pushes against the valve disk. The bottom end of the valve rod has a diameter slightly smaller than an inner diameter of the central passage to define a tiny gap between an inner surface of the central passage of the valve body and an outer surface of the bottom end of the valve rod. A flow notch is defined in outer surface of the bottom end of the valve rod and selectively aligns with the side opening in the valve body when the valve rod is rotated.

Other objects, advantages and novel features of the invention will become more apparent from the following detailed description when taken in conjunction with the accompanying drawings.

### BRIEF DESCRIPTION OF THE DRAWINGS

FIG. 1 is a cross sectional side plan view of a shock absorbing device in accordance with the present invention;

FIG. 2 is an exploded view of parts of the shock absorbing device in FIG. 1;

FIG. 3 is an enlarged exploded perspective view of the flow controlling valve of the shock absorbing device in FIG. 1;

FIG. 4 is an enlarged cross sectional side plan view of the flow controlling valve in FIG. 3;

FIG. 5 is a cross sectional top plan view of the flow controlling valve in FIG. 3 showing that the passage between the side opening and the central passage is completely closed;

FIG. 6 is an operational cross sectional top plan view of the flow controlling valve in FIG. 3 showing that the passage between the side opening and the central passage is partially opened;

FIG. 7 is an operational cross sectional top plan view of the flow controlling valve in FIG. 3 showing that the passage between the side opening and the central passage is fully opened; and

FIG. 8 a cross sectional side plan view of another embodiment of a shock absorbing device in accordance with the present invention.

### DETAILED DESCRIPTION OF PREFERRED EMBODIMENT

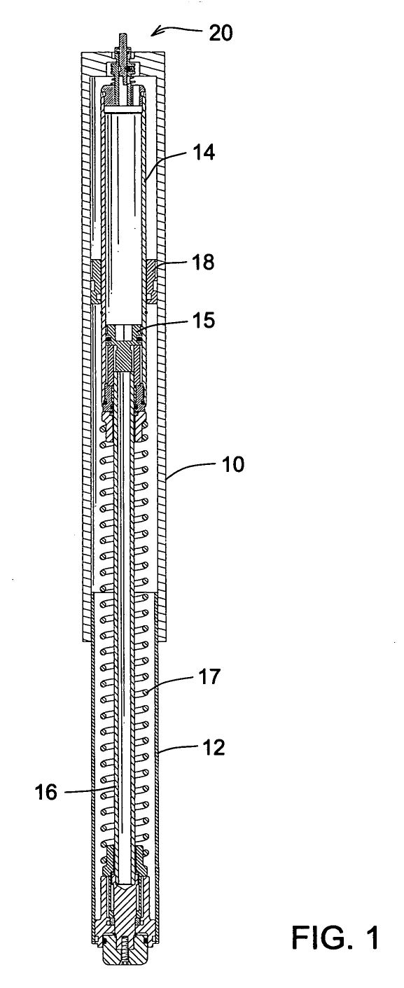

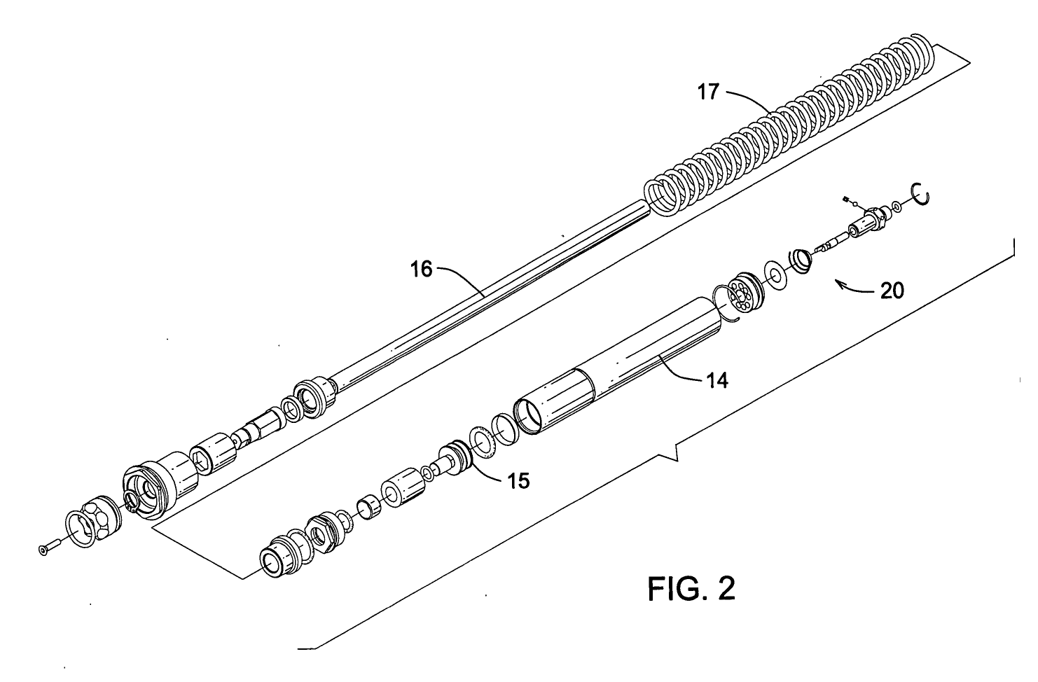

With reference to FIGS. 1 and 2, a shock absorbing device for a front fork of a bicycle comprises an outer tube (10), a sliding tube (12), an inner tube (14), a piston (15) and a flow controlling valve (20). The outer tube (10) has a closed top connected to a fork crown of the front fork, an open bottom and an inner space. The sliding tube (12) has an open top slidably extending into the open bottom of the outer tube (10), a closed bottom connected to a tip of the front fork and an inner space. The inner tube (14) is securely mounted inside the outer tube (10) and has a top, a bottom and an inner space. An oil passage is defined between the inner spaces of the outer tube (10), the sliding tube (12) and the inner tube (14) and is filled with oil.

The piston (15) is slidably mounted inside the inner tube (14) and is securely connected to the sliding tube (12) with a piston rod (16). The piston rod (16) has two ends attached respectively to the closed bottom of the sliding tube (12) and the piston (15), such that the piston (15) will slide inside the inner tube (14) while the sliding tube (12) moves relative to the outer tube (10). In addition, a spring (17) is mounted around the piston rod (16) and has two ends abutting respectively against the closed bottom of the sliding tube (12) and the bottom of the inner tube (14) to provide a recoil force to the sliding tube (12) and the piston (15).

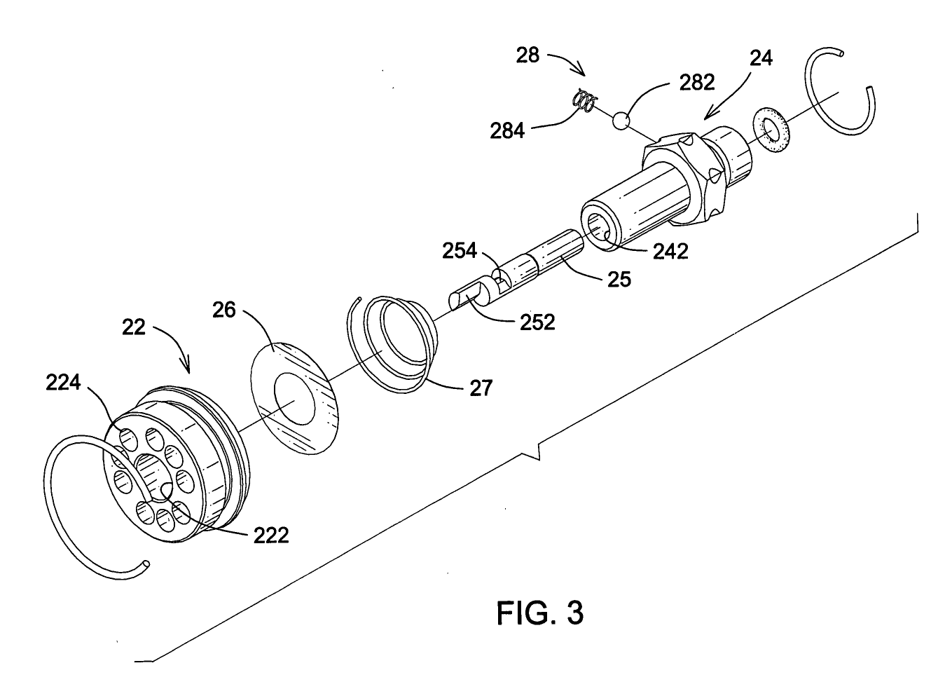

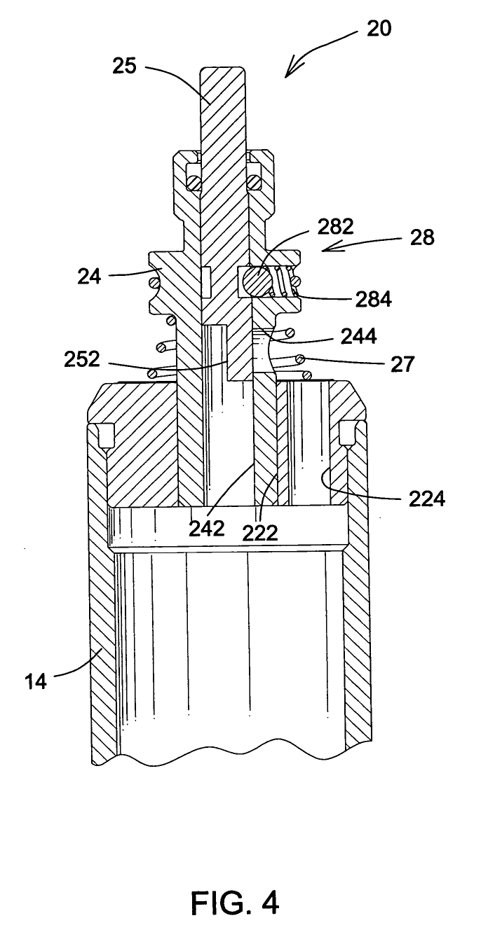

With further reference to FIGS. 3 and 4, the flow controlling valve (20) is attached to the top of the inner tube (14) to control the oil flow in the oil passage and comprises a plug (22), a valve body (24), a valve rod (25), a valve disk (26), a biasing member (27) and a positioning device (28).

The plug (22) is attached to the top of the inner tube (14) and has a central hole (222) and multiple channels (224) defined through the plug (22), wherein the channels (224) are arranged around the central hole (222).

The valve body (24) is attached to the plug (22) and has a central passage (242) defined through the valve body (24) and a side opening (244) radially defined in the valve body (24) and communicating with the central passage (242).

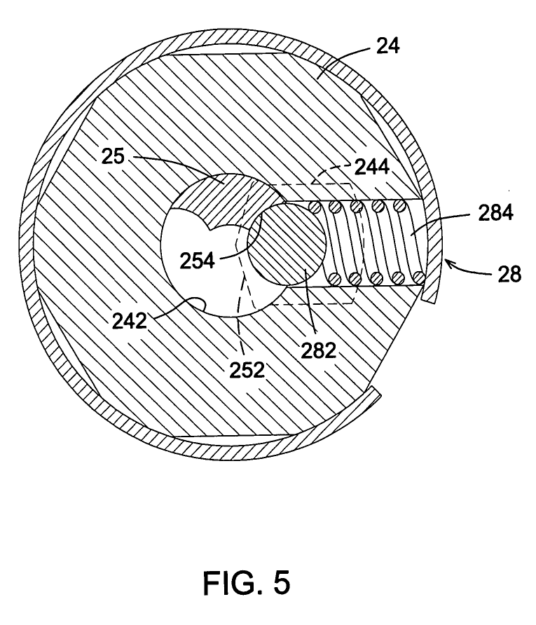

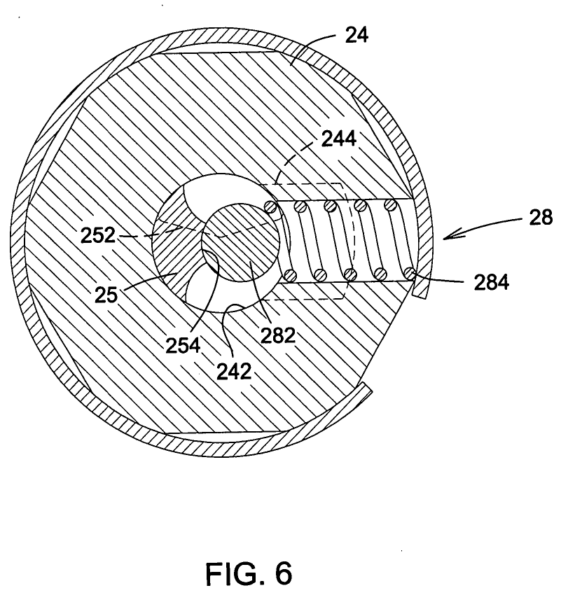

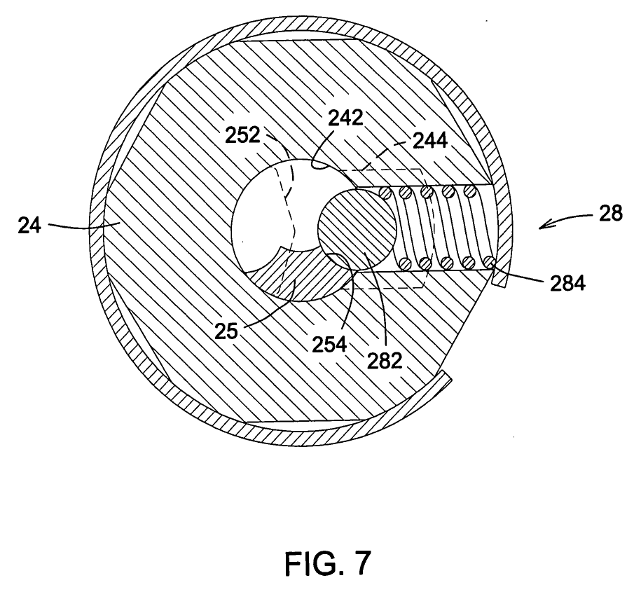

The valve rod (25) is rotatably mounted into the central passage (242) of the valve body (24) and has a top end and a bottom end corresponding to the side opening (244) in the valve body (24). The top end extends out of the central passage (242) in the valve body (24). A flow notch (252) is defined in the outer surface of the bottom end of the valve rod (25) and corresponds to and selectively communicates with the side opening (244) in the valve body (24). When a user rotates the valve rod (25) by hand to make the flow notch (252) align and communicate with the opening (244), as shown in FIGS. 6 and 7, a passage is defined between the central passage (242) and the side opening (244) in the valve body (24) to allow oil to flow into the central passage (242) from an inner space of the outer tube (10) through the passage. When the valve rod (25) is rotated to a position where the flow notch (252) does not communicate with the side opening (244), as shown in FIG. 5, the passage between the central passage (242) and the side opening (244) is closed and none of oil is allowed to flow into the central passage (244) from the inner space of the outer tube (10).

The valve disk (26) is attached to the plug (22) to close the channels (224) in the plug (22). The biasing member (27) is mounted around the valve body (24) and pushes against the valve disk (26).

With further reference to FIGS. 5 to 7, the positioning device (28) is mounted between the valve body (24) and the valve rod (25) to position the valve rod (25) relative to the valve body (24) at a desired place. The positioning device (28) comprises a ball (282), a spring (284) and multiple positioning notches (254). The ball (282) is mounted in the valve body (24) and partially extends into the central passage (242) in the valve body (24). The spring (284) is mounted in the valve body (24) and pushes against the ball (282). The positioning notches (254) are defined in the valve rod (25) and correspond to and selectively hold the ball (282). With the engagement between the ball (282) and one of the positioning notches (254), the valve rod (25) will be held in a desired place relative to the valve body (24).

With such a shock absorbing device, the sliding tube (12) will move upward relative to the outer tube (10) when an external force is applied to the front wheel of the bicycle. The piston (15) will move upward with the sliding tube (12), and the oil pressure in the inner space of the inner tube (14) increases. Consequently, the valve disk (26) will be pushed away from the channels (224) to make the channels (224) open, such that the oil in the inner space of the inner tube (14) will flow into the inner space of the outer tube (10) through the channels (224). With the oil flow in the shock absorbing device, the force will not be transmitted to the handlebars directly, and a shock absorbing effect is provided. In addition, the spring (17) can provide a further shock absorbing effect, and the shock absorbing effect of this device in accordance with the present invention is improved.

When the external force ceases, the piston (15) with the sliding tube (12) moves downward with the recoil force provided by the spring (17), and a vacuum effect occurs inside the inner space of the inner tube (14). At this time, the channels (224) in the plug (22) are closed by the valve disk (26) again, so that the oil in the inner space of the outer tube (10) will be sucked into the inner space of the inner tube (14) through the side opening (244) and the passage formed by the flow notch (252) in the valve rod (25).

In addition, when the valve rod (25) is rotated, the flow notch (252) is rotated to align selectively with the side opening (244) and the dimension of the passage between the central passage (242) and the side opening (244) is changed. Consequently, the speed of the oil flowing into the inner space of the inner tube (14) is adjusted, such that the return speed of the piston (15) and the sliding tube (12) is changed. In practice, the valve rod (25) can be rotated to completely close the passage formed by the flow notch (252), as shown in FIG. 5, and the shock-absorbing effect of this device is shut down. Consequently, the shock absorbing device will become a rigid element to keep the front fork moving relative to the handle of the bicycle, and the rider can conveniently rider the bicycle to go up a slope without the movement between the front fork and the handlebars. In addition, the valve rod (25) can be rotated to make the flow notch (252) fully align and communicate with the side opening, as shown in FIG. 7, such that the return speed of the oil flowing into the inner space of the inner tube (14) is at a fastest level. Consequently, the rider can ride the bicycle on a rugged and rough road conveniently. Thus, the shock absorbing device in accordance with the present invention can meet the different needs of users and is versatile in use.

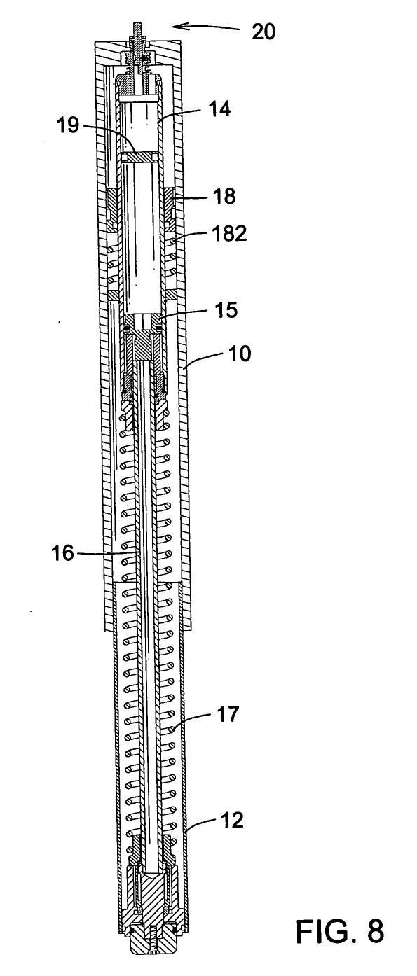

With reference to FIGS. 1 and 8, an outer piston (18) is mounted around the inner tube (14). The outer piston (18) will automatically move upward or downward with the pressure in the inner space of the outer tube (10) during the operation of the shock absorbing device. With reference to FIG. 8, a recoil spring (182) is mounted around the inner tube (14) and abuts with the outer piston (18) to provide a recoil force to the outer piston (18). Furthermore, a floating piston (19) is slidably mounted inside the inner space of the inner tube (14), and the floating piston (19) automatically moves upward and downward based on the pressure in the inner space of the inner tube (14).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A shock absorbing device for a front fork of a bicycle comprising:
an outer tube having a closed top, an open bottom and an inner space;
a sliding tube having an open top slidably extending into the open bottom of the outer tube, a closed bottom and an inner space;
an inner tube securely mounted inside the outer tube and having a top, a bottom and an inner space;
an oil passage defined between the inner space of the outer tube, the sliding tube and the inner tube and filled with oil;
a piston slidably mounted inside the inner tube and securely connected to the sliding tube with a piston rod;
a flow controlling valve attached to the top of the inner tube to control an oil flow of the oil in the oil passage and comprising:
a plug attached to the top of the inner tube and having a central hole and multiple channels defined through the plug, wherein the channels are arranged around the central hole;
a valve body attached to the plug and having a central passage defined through the valve body and a side opening radially defined in the valve body and communicating with the central passage;
a valve rod rotatably mounted into the central passage of the valve body and having a bottom end corresponding to the side opening in the valve body;
a valve disk attached to the plug to close the channels in the plug; and
a biasing member mounted around the valve body and pushing against the valve disk,
wherein a flow notch is defined in outer surface of the bottom end of the valve rod and selectively aligning and communicating with the side opening in the valve body to selectively define a passage between the side opening and the central passage in the valve body when the valve rod is rotated.

2. The shock absorbing device as claimed in claim 1, wherein the piston rod has two ends attached respectively to the closed bottom of the sliding tube and the piston.

3. The shock absorbing device as claimed in claim 2 further comprising a spring mounted around the piston rod and having two ends abutting respectively against the closed bottom of the sliding tube and the bottom of the inner tube to provide a recoil force to the sliding tube and the piston.

4. The shock absorbing device as claimed in claim 3 further comprising an outer piston mounted around the inner tube.

5. The shock absorbing device as claimed in claim 4 further comprising a recoil spring mounted around the inner tube and abutting with the outer piston to provide a recoil force to the outer piston.

6. The shock absorbing device as claimed in claim 5 further comprising a floating piston slidably mounted inside the inner space of the inner tube.

7. The shock absorbing device as claimed in claim 6, wherein the flow controlling valve further comprises a positioning device mounted between the valve body and the valve rod to position the valve rod relative to the valve body at a desired place.

8. The shock absorbing device as claimed in claim 7, wherein the positioning device comprises
a ball mounted in the valve body and partially extends into the central passage in the valve body;
a spring mounted in the valve body and pushing against the ball;
multiple positioning notches defined in the valve rod and corresponding to and selectively holding the ball.

9. The shock absorbing device as claimed in claim 1 further comprising a spring mounted around the piston rod and having two ends abutting respectively against the closed bottom of the sliding tube and the bottom of the inner tube to provide a recoil force to the sliding tube and the piston.

10. The shock absorbing device as claimed in claim 9 further comprising an outer piston mounted around the inner tube.

11. The shock absorbing device as claimed in claim 10 further comprising a recoil spring mounted around the inner tube and abutting with the outer piston to provide a recoil force to the outer piston.

12. The shock absorbing device as claimed in claim 11 further comprising a floating piston slidably mounted inside the inner space of the inner tube.

13. The shock absorbing device as claimed in claim 12, wherein the flow controlling valve further comprises a positioning device mounted between the valve body and the valve rod to position the valve rod relative to the valve body at a desired place.

14. The shock absorbing device as claimed in claim 13, wherein the positioning device comprises
a ball mounted in the valve body and partially extends into the central passage in the valve body;
a spring mounted in the valve body and pushing against the ball;
multiple positioning notches defined in the valve rod and corresponding to and selectively holding the ball.

15. The shock absorbing device as claimed in claim 1 further comprising an outer piston mounted around the inner tube.

16. The shock absorbing device as claimed in claim 15 further comprising a recoil spring mounted around the inner tube and abutting with the outer piston to provide a recoil force to the outer piston.

17. The shock absorbing device as claimed in claim 16 further comprising a floating piston slidably mounted inside the inner space of the inner tube.

18. The shock absorbing device as claimed in claim 1 further comprising a floating piston slidably mounted inside the inner space of the inner tube.

19. The shock absorbing device as claimed in claim 1, wherein the flow controlling valve further comprises a positioning device mounted between the valve body and the valve rod to position the valve rod relative to the valve body at a desired place.

20. The shock absorbing device as claimed in claim 19, wherein the positioning device comprises
a ball mounted in the valve body and partially extends into the central passage in the valve body;
a spring mounted in the valve body and pushing against the ball;
multiple positioning notches defined in the valve rod and corresponding to and selectively holding the ball.
